(19) United States
(12) Patent Application Publication
(10) Pub. No.: US 2011/0069852 A1
(43) Pub. Date: Mar. 24, 2011

(54) Hearing Aid

(76) Inventors: Georg-Erwin Arndt, Obermichelbach (DE); Anton Gebert, Kleinsendelbach (DE); Volker Gebhardt, Neunkirchen am Brand (DE); Oleg Saltykov, Fairlawn, NJ (US)

(21) Appl. No.: 12/630,549

(22) Filed: Dec. 3, 2009

Related U.S. Application Data
(60) Provisional application No. 61/245,052, filed on Sep. 23, 2009.

(51) Int. Cl. H04R 25/02; H04R 25/00

(52) U.S. Cl. 381/317; 381/328

(57) ABSTRACT

A hearing aid (10) having an active occlusion reduction system (50) that counteracts occluded sounds generated within the volume (24) of the ear canal (20) that is not blocked when the hearing aid (10), or an ear piece thereof, is inserted into the ear canal (20) and an AOR transducer (44, 52) that has a flattened frequency response for low frequency portions of the occlusion sounds to enable a wide range of frequency response by the active occlusion reduction system (50). The low frequency portions of the occlusion sounds may be in the range of 10-100 Hz.

### RELATED APPLICATIONS

The present patent document claims the benefit of the filing date under 35 U.S.C. §119(e) of Provisional U.S. Patent Application Ser. No. 61/245,052, filed Sep. 23, 2009, which is hereby incorporated by reference.

### FIELD OF INVENTION

The present invention relates to a hearing aid. More particularly, the present invention relates to a hearing aid that provides occlusion reduction.

### BACKGROUND OF THE INVENTION

A conventional hearing aid typically comprises a housing that defines a generally closed cavity therein in which are arranged a power source, an input transducer, for example, a microphone, and associated amplifier for transforming external sounds into electrical signals, a signal processor for processing the transformed signals and producing signals optimized for particular hearing losses, and an output transducer, called a receiver, for transforming the processor signals into hearing-loss compensated sounds that are emitted into the ear. A hearing aid typically also comprises respective sound tubes extending from the input port of the microphone or the output port of the receiver to the housing outside surface to establish acoustic pathways between the microphone and the outside surroundings and between the receiver and the ear canal, respectively.

Hearing aids may be constructed to be wearable in the ear (for example, in-the-ear (ITE); in-the-canal (ITC), and completely-in-the-canal (CIC) hearing aids). For this type of hearing aid, the ear canal is either partially or completely closed off from the surroundings outside the ear. So-called “occlusion effects” are a consequence of this occlusion of the ear canal. Specifically, there occurs a pressure build-up in the residual volume of the unblocked portion of the ear canal, defined by the hearing aid and the ear drum, from the sound emitted by the vibration of the tissue in the ear canal that is normally caused by the voice of the hearing aid user. The voice of the hearing aid user becomes amplified and hollow and dominates the sounds reaching the ear drum. This results in poor sound quality of the user's own voice as well as the other sounds reaching the ear drum.

There are several ways to diminish or reduce these occlusion effects. For example, a hearing aid can be inserted, with a seal, deeply in the ear canal (the bony tissue part) so that the residual volume is not only reduced but also isolated from the portion of the ear canal (the soft tissue part) that mainly conducts a user's voice. Unfortunately, this type of insertion usually causes physical discomfort for the user since the bony tissue part of the ear canal is very sensitive to the contact with the hearing aid.

More commonly, a hearing aid will be configured to have at least one ventilation channel or passage (“vent”) that extends from the portion of the hearing aid housing facing the residual volume to the portion of the hearing aid housing facing outside the ear. The vent facilitates transmission of acoustic energy from one side of the hearing aid to the other so that the ear canal is not completely blocked. The vent thus reduces occlusion effects by, first, providing a passageway to permit the body-conducted portion of a user's own voice to dissipate and, second, equalizing the atmospheric pressure between the air in the outside surroundings and in the residual volume. Disadvantageously, the vent also provides an acoustic bypass to the normal signal path via the hearing aid components (for example, the microphone, the signal processor, and the receiver). This bypass can reduce the efficiency of the hearing aid, for example, directionality or noise reduction, particularly in loud acoustic situations. Further, this bypass often gives rise to acoustical positive feedback because part of the acoustic energy produced by the receiver in the ear canal reaches, via the vent, the microphone, particularly in quiet acoustic situations that require high amplification by the hearing aid.

A hearing aid vent can be formed in various ways, for example, as a thin hose or a tube extending through the hearing aid housing, or as a channel formed along the housing outside surface, or as a passage formed in an outside wall of the housing. To address occlusion effects, the vent should be configured with a relatively large diameter or cross-sectional size, especially to permit appropriate venting of the body-conducted portion of a user's own voice, which is most evident at low frequencies. In contrast, to minimize the acoustic bypass effects which also arise mostly at low frequencies, the vent should be configured with a diameter or cross-sectional size as small as possible. Normally, the vent sizing is adjusted, via various known means, during the adaptation of the hearing aid to the user so that the hearing aid is relatively free of feedback. Vent sizing is usually a compromise between hearing aid performance and user comfort.

More recently, hearing aids have been constructed with active occlusion reduction (AOR) circuitry. U.S. Patent Publication 200810063228 (“Mejia, et al.”) shows a hearing aid having AOR circuitry. Hearing aids with AOR circuitry generally comprise a second input transducer (referred to as an “AOR microphone”) that is located inside the hearing aid housing facing the residual volume of the ear canal and that picks up all sounds, including occlusion sounds in the residual volume. The picked-up sounds are processed and combined with the processed external sounds picked up by the external microphone. The hearing aid having AOR circuitry treats the occlusion sounds in the residual volume as an error in a closed-loop feedback system. In particular, the hearing aid having AOR circuitry uses the occlusion sound signals to generate compensating sound signals (“occlusion-negating sounds”) that are projected by the receiver into the residual volume (which also projects the hearing-loss compensated sounds). The occlusion sounds in the residual volume get compensated as they combine with occlusion-negating sounds that the hearing aid generates. A hearing aid having AOR circuitry is typically still configured to have a conventional vent as well, with comparatively small dimensions, not to address occlusion reduction but to provide frequency response stability and balance barometric pressure differentials.

Due to the limited bandwidth of hearing aid AOR transducers (specifically, the receiver and the AOR microphone) as well as processing delays, one adverse effect of a hearing aid having AOR circuitry is that the negative feedback of the closed-loop AOR system at 100-1000 Hz turns into positive feedback below 100 Hz, creating a gain boost between 10 and 100 Hz. A well-tuned and optimized hearing aid having AOR circuitry typically has a resonance peak of 5-10 dB between 10 and 100 Hz. As a result, sound in the frequency range of the resonance peak which is entering the hearing aid is amplified. This low frequency amplification is perceived as a very annoying artifact to the user. Hearing aid signal processing offers no suitable counteraction for the amplification of the entering low frequency sound because frequencies up to 200 Hz are passing through a typical hearing aid vent having a 1 mm diameter.

### SUMMARY OF THE INVENTION

The above problems are obviated by the present invention which provides an active occlusion reduction system that counteracts occlusion sounds generated within the volume of the ear canal that is not blocked when the hearing aid, or an ear piece thereof, is inserted into the ear canal; and an AOR transducer that has a flattened frequency response for low frequency portions of the occlusion sounds to enable a wide range of frequency response by the active occlusion reduction system. The AOR transducer may diminish the artifacts resulting from low frequency amplification caused by the active occlusion reduction system. Further, the low frequency portions of the occlusion sounds may be in the range of 10-100 Hz.

Alternatively, the present invention provides an external microphone that converts ambient sounds originating outside the ear into first representative electrical signals; an internal microphone that converts sounds originating inside the ear canal, including at least occlusion sounds, into second representative electrical signals; a signal processing system operatively coupled between the external microphone and the internal microphone that modifies and combines the first and second electrical signals to generate third representative electrical signals; and a receiver that converts the third representative electrical signals into hearing-loss compensating sounds and occlusion-negating sounds and projects the hearing-loss compensating sounds and occlusion-negating sounds into the ear canal, at least one of the receiver and the internal microphone configured with a vent into the volume of the hearing aid. Either the receiver and internal microphone, or both, may comprise a vent opening formed between the rear volume of the receiver and the closed cavity of the hearing aid. The vent opening of the receiver may be formed with a diameter within the range of 0.01 to 0.05 mm and a length of approximately 0.2 mm whereas the vent opening of the internal microphone may be formed with a diameter within the range of 0.01 to 0.03 mm and a length of approximately 0.015 mm. Alternatively, the vent opening of the receiver or the internal microphone, or both, may be formed with a diameter within the range of 0.5 to 1 mm with the transducer further comprising an acoustic resistor adapted to overlie the vent opening. Alternatively, for either the receiver or internal microphone, or both, the vent opening may be formed as an aperture in the portion of the hearing aid defining the rear volume and a thin tube extending from the aperture into the closed cavity of the hearing aid.

Alternatively, the present invention provides an active occlusion reduction system having at least one vented AOR transducer. The AOR transducer may comprise a housing; a generally closed volume defined by the housing in which are arranged transducer components; a sound inlet/outlet port that is adapted to receive or project acoustic signals, respectively; a portion of the housing that defines a rear volume of the transducer; and a vent opening formed in the housing between the rear volume and a closed cavity of the hearing aid. The AOR transducer may further comprise an acoustic resistor adapted to overlie the vent opening. Alternatively, the AOR transducer may further comprise a thin tube extending from the vent opening into the closed cavity of the hearing aid.

The present invention may also provide an active occlusion reduction system, comprising a vented in-the-ear transducer. The present invention may also provide an active occlusion reduction system, comprising a receiver; an AOR microphone, at least one of the receiver and the AOR microphone being vented; and a closed-loop feedback system operatively coupled between the receiver and the AOR microphone that enables the receiver to output occlusion-negating sounds to compensate for occlusion sounds received by the AOR microphone.

### DESCRIPTION OF THE DRAWINGS

For a better understanding of the present invention, reference is made to the following description of an exemplary embodiment thereof, and to the accompanying drawings, wherein:

FIG. 1 is a diagrammatic representation of a hearing aid having active occlusion reduction (AOR) circuitry constructed according to the present invention;

FIG. 2 is a schematic representation of a transducer of a conventional hearing aid having AOR circuitry;

FIG. 3 a, b, c are alternative schematic representations of an AOR transducer of the hearing aid of FIG. 1;

FIG. 4 shows a simulated frequency response of a conventional AOR microphone and an AOR microphone of the hearing aid of FIG. 1;

FIG. 5 shows a simulated frequency response of a conventional receiver and a receiver of the hearing aid of FIG. 1;

FIG. 6 shows amplitude and phase responses of simulated transducer transfer functions of a conventional hearing aid having AOR circuitry and the hearing aid of FIG. 1; and

FIG. 7 shows simulated closed loop responses of a conventional hearing aid without AOR circuitry; a conventional hearing aid having AOR circuitry; and the hearing aid of FIG. 1.

### DETAILED DESCRIPTION

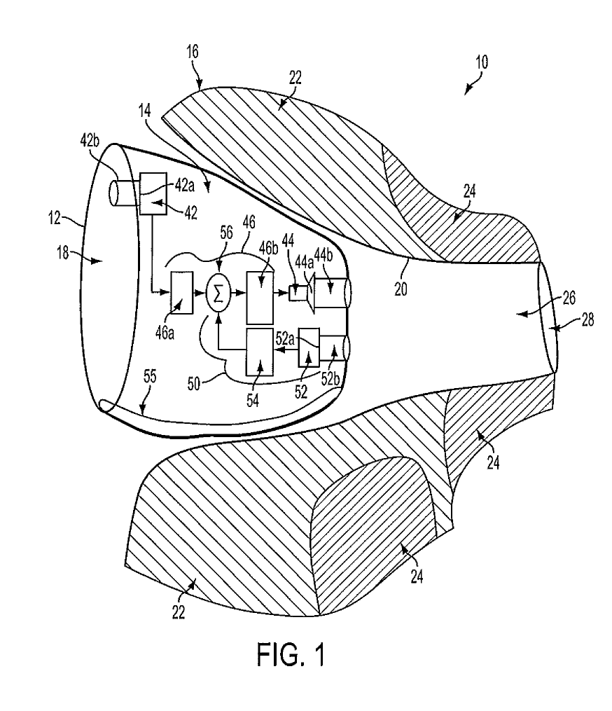

FIG. 1 is a diagrammatic representation of a hearing aid 10 constructed according to the present invention. The hearing aid 10 comprises a housing or shell 12 that defines a generally closed cavity 14 therein in which are arranged the hearing aid components. The hearing aid 10 is configured to be snugly fit in a user's ear 16 so that one end of the aid 10 faces the outside surroundings (faceplate 18); the middle portion of the aid 10 rests in and blocks the ear canal 20 along soft ear tissue 22; and the other end of the aid 10 faces the residual volume 26 of the unblocked portion of the ear canal 20 defined by the housing 12 of the hearing aid 10 and the ear drum 28. The residual volume 24 typically encompasses soft ear tissue 22 as well as bony tissue 24 of the ear canal 20. The hearing aid 10 is made of conventional materials and may be manufactured by various methods. The hearing aid 10 also may be configured in various forms.

The hearing aid 10 components include but are not limited to a power source (not shown), typically a battery, and an input transducer 42, for example, a microphone. These components are conventional and well known, and can be operatively connected in well-known manners. The input transducer 42 is also referred to as an external microphone and serves to receive acoustic signals, i.e., sounds, from the outside surroundings and convert the sounds into electrical signals for further processing by the other components of the aid 10. The external microphone 42 is arranged within the aid cavity 14 so that its sound input port 42a is adjacent to and operatively connected with an opening in the faceplate 18. The aid 10 may also include a microphone sound tube 42b that may be integrally formed in the housing 12 or the external microphone 42 and that extends from the input port 42a of the external microphone 42 to the outside surface of the faceplate 18 to establish an acoustic pathway between the external microphone 42 and the outside surroundings.

The hearing aid 10 components further include an output transducer 44, referred to as a receiver, and signal processing circuitry 46. The signal processing circuitry 46 includes but is not limited to an amplifier 46a that amplifies the converted signals from the external microphone 42 and a signal processor 46b that modifies the converted signals, for example, dampens and/or filters interference signals. As described below in more detail, a summation circuit 56 of active occlusion reduction (AOR) circuitry 50 is connected to the signal path of the signal processing circuitry 46 so that the converted signals are first input into the summation circuit 56 and the summation circuit 56 output is modified by the signal processor 46b. The receiver 44 serves to receive the processed signals from the signal processing circuitry 46, convert the signals into acoustic signals, and project the acoustic signals into the residual volume 26 of the ear canal 20. The receiver 44 is arranged within the aid cavity 14 so that its sound output port 44a is adjacent to and operatively connected with an opening in the housing 12 facing the residual volume 26. The aid 10 may also include a receiver sound tube 44b that may be integrally formed in the housing 12 or the receiver 44 and that extends from the output port 44a of the receiver 44 to the outside surface of the housing 12 to establish an acoustic pathway between the receiver 44 and the residual volume 26.

The hearing aid 10 components further include active occlusion reduction (AOR) circuitry 50. The AOR circuitry 50 includes a second input transducer 52, for example, a microphone. The second input transducer 52 is also referred to as an AOR microphone and serves to receive acoustic signals, i.e., sounds, from the residual volume 26 and convert the sounds into electrical signals for further processing by an AOR microphone processor 54 of the AOR circuitry 50. The AOR microphone processor 54 serves to modify the converted signals. The summation circuit 56 of the AOR circuitry 50 receives the processed signals from the AOR microphone processor 54 and the converted signals from the amplifier 46a. The signal processor 46b receives and modifies the summation circuit 56 output. The receiver 44 receives the processed signals from the signal processor 46b, converts the signals into acoustic signals, and projects the acoustic signals into the residual volume 26 of the ear canal 20. Alternatively, the summation circuit 56 may be connected to the signal path of the signal processing circuitry 46 to receive the processed signals from the signal processor 46b, rather than the converted signals from the amplifier 46a, and the processed signals from the AOR microphone processor 54 and to output a combined signal to the receiver 44. The receiver 44, the signal processing circuitry 46, and the AOR circuitry 50 are conventional components and can be operatively connected in various well-known manners.

Similar to the other transducers 42, 44, the AOR microphone 52 is arranged within the aid cavity 14 so that its sound input port 52a is adjacent to and operatively connected with an opening in the housing 12 facing the residual volume 26. The aid 10 may also include an AOR microphone sound tube 52b that may be integrally formed in the housing 12 or the AOR microphone 52 and that extends from the input port 52a of the AOR microphone 52 to the outside surface of the housing 12 to establish an acoustic pathway between the AOR microphone 52 and the residual volume 26. As described in detail with reference to FIGS. 3-7, either the receiver 44 or the AOR microphone 52, or both, are configured to assist the AOR circuitry 50 in achieving occlusion reduction in accordance with the present invention.

To achieve barometric pressure relief, the hearing aid 10 may include a very small-sized vent 55 in the housing 12 of the hearing aid 10. The vent 55 can be formed in various ways, for example, as a thin hose or a tube extending through the housing 12, or as a channel formed along the housing 12 outside surface, or as a passage formed in an outside wall of the housing 12. The vent 55 facilitates transmission of acoustic energy from one side of the hearing aid 10 to the other so that the ear canal 20 is not completely blocked.

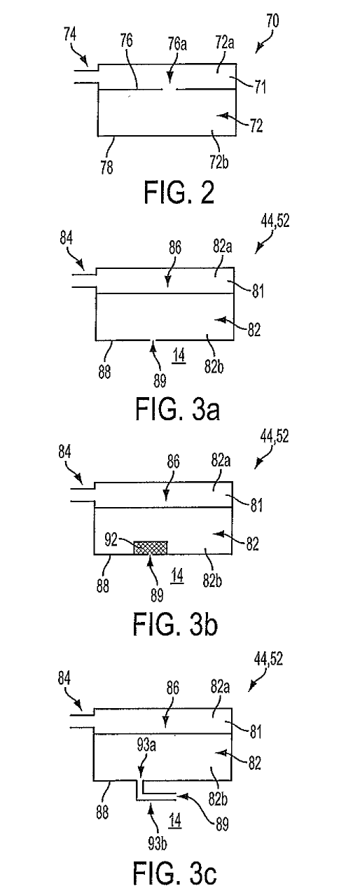

FIG. 2 is a schematic representation of a transducer 70 of a conventional hearing aid having active occlusion reduction circuitry. The transducer 70 comprises a housing 71 that defines a generally closed volume 72 therein in which are arranged the transducer components (not shown). The housing 71 is configured to have a sound inlet port (for an external microphone or AOR microphone) or sound outlet port 74 (for a receiver) that is adapted to receive acoustic signals from outside of the transducer 70 or project acoustic signals to outside of the transducer 70, respectively. The transducer volume 72 is separated into two volumes 72a, 72b by a membrane 76, a front volume 72a containing the pathway to the sound inlet/outlet port 74 and to the transducer components and a rear volume 72b defined by a portion 78 of the housing 71 away from the sound inlet/outlet port 74. The membrane 76 has an aperture 76a formed there through that provides a pathway between the two volumes 72a, 72b and provides pressure relief between the two volumes. The housing of the transducer 70 may be configured in various known forms.

FIGS. 3 a, b, c are alternative schematic representations of the receiver 44 or the AOR microphone 52, or both, of the hearing aid 10. Like the transducer 70 of a conventional hearing aid, the receiver 44 or AOR microphone 52, or both, comprises a housing 81 that defines a generally closed volume 82 therein in which are arranged the transducer components (not shown). The housing 81 is configured to have a sound inlet port (for the internal microphone 52) or outlet port 84 (for the receiver 44) that is adapted to receive or project acoustic signals, respectively. The transducer volume 82 is separated into two volumes 82a, 82b by a closed membrane 86, a front volume 82a containing the pathway to the sound inlet/outlet port 84 and to the transducer components and a rear volume 82b defined by a portion 88 of the housing 81 of the receiver 44 or AOR microphone 52 away from the sound inlet/outlet port 84. In a first embodiment shown in FIG. 3a, the housing 81 has a vent opening 89 formed in the rear volume 82b. The vent opening 89 forms a pathway to the closed cavity 14 of the housing 12. As a practical matter, the vent opening 89 for the receiver 44 can be formed in the range 0.01-0.05 mm diameter×0.2 mm length and for the AOR microphone 52 can be formed in the range 0.01-0.03 mm diameter×0.015 mm length.

In a second embodiment shown in FIG. 3b, the housing 81 has a vent opening 89 formed in the rear volume 82b as well. In addition, the vent opening 89 can be covered by an acoustic resistor 92. In such case, the vent opening 88 formed is similar to that of the first embodiment shown in FIG. 3a but it can be formed with larger dimensions. As a practical matter, the vent opening 89 for the receiver 44 and for the AOR microphone 52 can both be formed in the range 0.5-1 mm diameter. The value of the acoustic resistor can be 1×10¹⁰ mks acoustic ohms±50% for the receiver 44 and 1×10¹⁰ mks acoustic ohms±50% for the AOR microphone 52, optimized for the particular transducer. In a third embodiment shown in FIG. 3c, the housing 81 has a vent opening 89 formed in the rear volume 82b as an aperture 93a with an attached thin tube 93b extending from the aperture 93a into the closed cavity 14 of the aid housing 12. The tube 93b may be formed integral with the rear portion 88 of the transducer housing 81 or as a separately attached element.

In operation, the external microphone 42 picks up sounds from the outside surroundings of the ear 16 via its sound input port 42a. The external microphone 42 converts the sounds into electrical signals that are passed to the signal processing circuitry 46 of the aid 10 and, in particular, the amplifier 46a which amplifies the electrical signals. The converted signals are then passed through a summation circuit 52 of the AOR circuitry 30 which passes its output to the signal processor 46b. The signal processor 46b modifies the received signals, for example, by dampening and/or filtering interference, and passes processed signals to the receiver 44. The receiver 44 converts the processed signals into acoustic signals and projects, via its sound outlet port 44a, the acoustic signals into the residual volume 26 of the ear canal 20.

At the same time and separately, the AOR microphone 52 picks up acoustic signals from the residual volume 26 via its sound input port 52a and converts the acoustic signals into electrical signals that are passed to the AOR microphone processor 54. The picked-up acoustic signals include both the acoustic signals projected by the receiver 44 and any occlusion sounds in the residual volume 24 from various sources, including body-conducted sounds. The AOR microphone processor 54 modifies the converted signals, for example, by amplifying and/or filtering. The summation circuit 52 combines the processed internal sounds with the converted signals outputted from the external microphone 42 and the associated amplifier 46a. The signal processor 46b receives and modifies the summation circuit 56 output and the receiver 44 converts the processed signals from the signal processor 46b into acoustic signals and projects the acoustic signals into the residual volume 26. Alternatively, the various components may be configured so that the summation circuit 56 is connected to the signal path of the signal processing circuitry 46 to receive the processed signals from the signal processor 46b, rather than the converted signals from the amplifier 46a, and the processed signals from the AOR microphone processor 54 and to output a combined signal to the receiver 44.

The AOR circuitry 50 treats an occlusion sound in the residual volume 24 as an error in a closed-loop feedback system and, in particular, uses the occlusion sounds to generate compensating sound signals (“occlusion-negating sounds”) that are projected by the receiver 44 into the residual volume 24 (which also projects the hearing-loss compensated sounds). As a result, the user hears only, or primarily, hearing-loss compensated sounds (representing sounds from the outside surroundings) since any occlusion sounds get compensated as they combine with occlusion-negating sounds that the aid 10 generates.

As mentioned above, using a conventional hearing aid with AOR circuitry has adverse effects and does not provide a wide range of low frequency response. The limited bandwidth of the AOR transducers (receiver and AOR microphone), for example, like the one shown if FIG. 2, is a particular problem. The configuration of the AOR transducers, especially the aperture 76a of the membrane 76, creates a roll-off of the low frequency response of the transducer (i.e., the low frequency response is not flat and attenuates at frequencies lower than 100 Hz). The present invention, in contrast, provides for AOR transducers 44, 52 that generate a more flat response at those same low frequencies. As the membrane 86 vibrates, the sound pressure in the closed volume 82 of the transducer 44, 52, either coming in as an input signal or going out as an output signal, is leaked to the closed cavity 14 of the housing 12 via the vent opening 89 and gets equalized. The vent opening 89 acts as an acoustic equivalent of a resistor and inductor combination and the closed cavity 14 of the housing 12 acts as a compliance. At low frequencies, the membrane 86 vibration (and thus the transducer 44, 52 response) would normally be diminished but the vent opening 89 and the closed cavity 14 permits the response to be flattened.

The responses of the receiver 44 and/or the AOR microphone 52, as well as the overall response of the AOR circuitry 50, is flatter and smoother than without the vented AOR transducers 44, 52 and the Q-factor of the low-frequency resonance AOR system becomes low. The low frequency amplification effect (and resulting artifacts) is strongly decreased and shifted to the less-audible frequency range and may even be avoided.

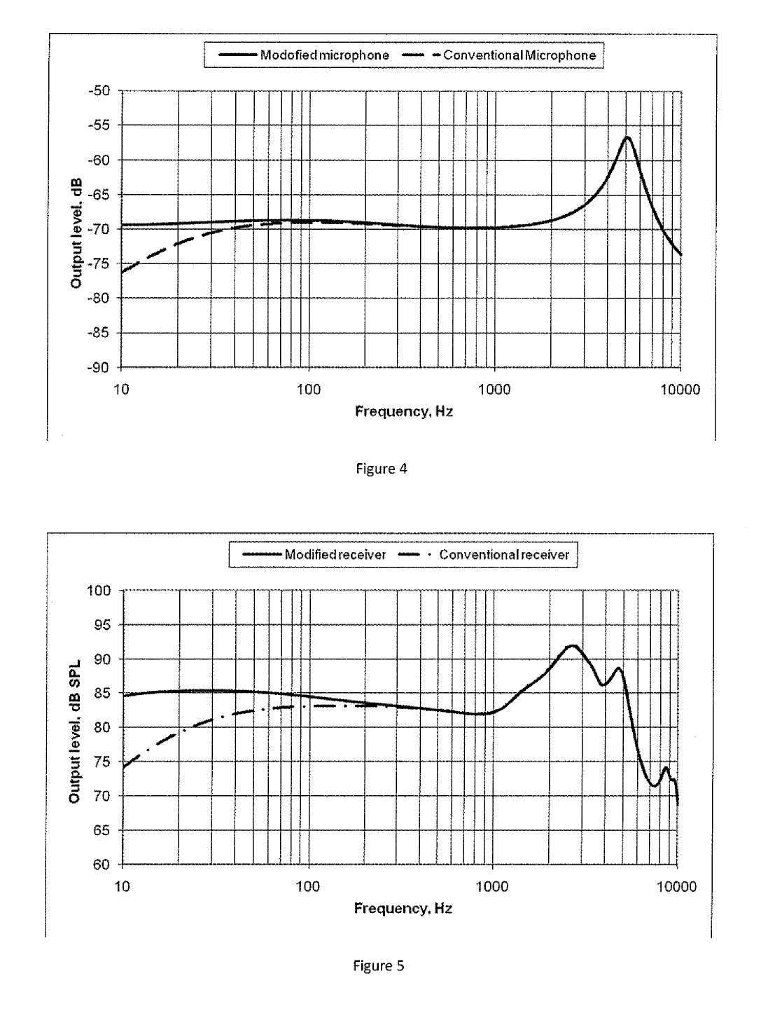

The AOR transducers 44, 52 provided by the present invention have greatly improved low-frequency responses and the hearing aid 10 having AOR circuitry 50 achieves better occlusion reduction in a wider frequency range. This is graphically seen in FIGS. 4-7. FIG. 4 shows a simulated frequency response of a conventional AOR microphone and an AOR microphone 52 of the aid 10 constructed in accordance with the present invention. The simulation is done without a conventional vent in the housing 12 of the aid 10. FIG. 5 shows a simulated frequency response of a conventional receiver and a receiver 44 of the aid 10 constructed in accordance with the present invention. The simulation is done without a conventional vent in the housing 12 of the aid 10.

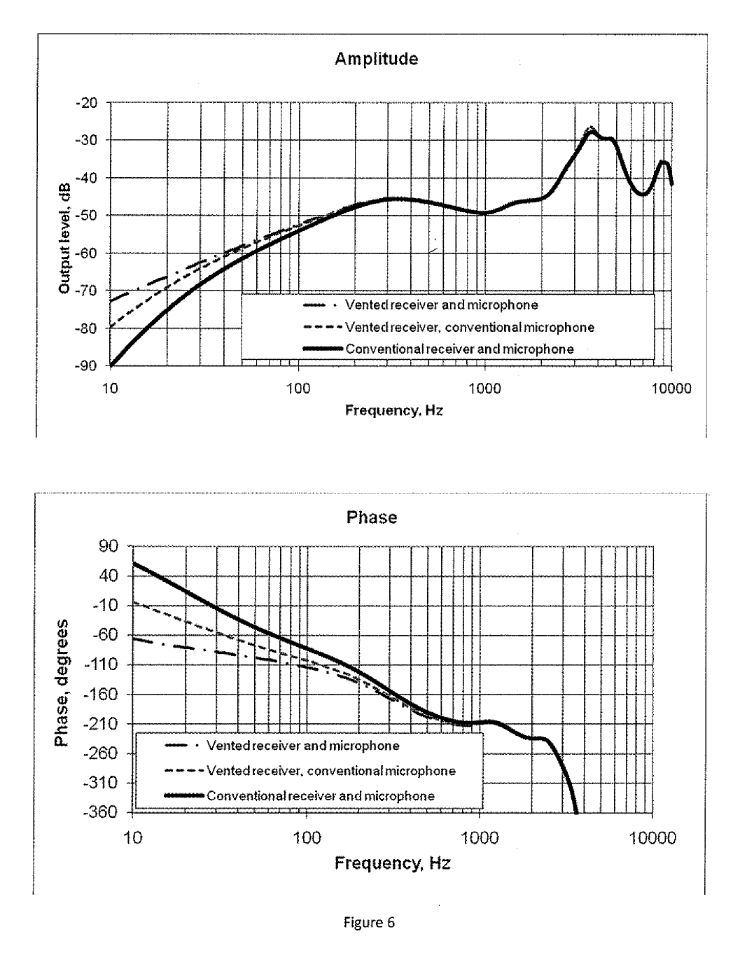

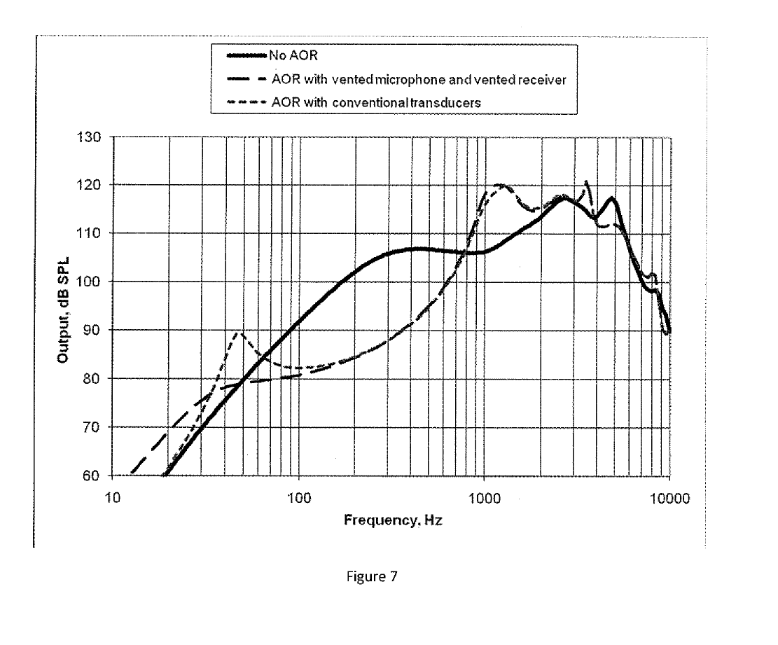

FIG. 6 shows amplitude and phase responses of simulated transducer transfer functions of a hearing aid having AOR circuitry with a) conventional transducers (receiver and AOR microphone); b) a receiver 44 of the aid 10 constructed in accordance with the present invention and a conventional AOR microphone; and c) both AOR transducers of the aid 10 constructed in accordance with the present invention (the receiver 44 and the AOR microphone 52). The simulations are done with a conventional vent, 1 mm in diameter and 1.5 mm in length, in the housing of the hearing aid. FIG. 7 shows simulated closed loop responses of a hearing aid having a) no AOR circuitry; b) AOR circuitry with conventional AOR transducers (receiver and AOR microphone); and c) AOR circuitry with both AOR transducers of the aid 10 constructed in accordance with the present invention (the receiver 44 and the AOR microphone 52). Compared to the performance of the hearing aid having AOR circuitry with conventional AOR transducers, the stability of the hearing aid 10 having AOR circuitry in accordance with the present invention and its sensitivity to low-frequency disturbances is greatly improved using vented AOR transducers 44, 52.

Other modifications are possible within the scope of the invention. For example, the signal processing circuitry 46 and the AOR circuitry 50 are conventional and well known components, and can be configured and operatively connected in well-known ways other than those described above. Further, the hearing aid 10 components may be analog or digital components, or mixed, as preferred.

Importantly, the hearing aid 10 may be a behind-the-ear (BTE) type with an earmold worn in the ear or any other acoustic-controlling device that either partially or completely closes off the ear canal from the surroundings outside the ear, for example, an in-the-ear headset or a sound protector. A BTE hearing aid is commonly used by a user with severe hearing loss who requires high-power amplification. A BTE hearing aid separates the receiver from the main body of the aid and may mount it directly in an earmold that is snugly fit into the user's ear canal. A BTE hearing aid having AOR circuitry also has an AOR microphone that may be mounted directly in the earmold. The present invention provides improved occlusion reduction in such cases.

What is claimed is:

1. An active occlusion reduction system, comprising a vented in-the-ear transducer.

2. An active occlusion reduction system, comprising:
a. a receiver;
b. an AOR microphone, at least one of the receiver and the AOR microphone being vented; and
c. a closed-loop feedback system operatively coupled between the receiver and the AOR microphone that enables the receiver to output occlusion-negating sounds to compensate for occlusion sounds received by the AOR microphone.

3. A hearing aid, comprising an active occlusion reduction system having at least one vented AOR transducer.

4. The hearing aid of claim 3, wherein the at least one vented AOR transducer comprises a housing; a generally closed volume defined by the housing in which are arranged transducer components; a sound inlet/outlet port that is adapted to receive or project acoustic signals, respectively; a portion of the housing that defines a rear volume of the transducer; and a vent opening formed in the housing between the rear volume and a closed cavity of the hearing aid.

5. The hearing aid of claim 4, wherein the at least one vented AOR transducer further comprises an acoustic resistor adapted to overlie the vent opening.

6. The hearing aid of claim 4, wherein the at least one vented AOR transducer further comprises a thin tube extending from the vent opening into the closed cavity of the hearing aid.

7. A hearing aid, comprising:
a. An active occlusion reduction system that counteracts occlusion sounds generated within the volume of the ear canal that is not blocked when the hearing aid, or an ear piece thereof, is inserted into the ear canal; and
b. An AOR transducer that has a flattened frequency response for low frequency portions of the occlusion sounds to enable a wide range of frequency response by the active occlusion reduction system.

8. The hearing aid of claim 7, wherein the AOR transducer diminishes the artifacts resulting from low frequency amplification caused by the active occlusion reduction system.

9. The hearing aid of claim 7, wherein the low frequency portions of the occlusion sounds are in the range of 10-100 Hz.

10. A hearing aid, comprising:
a. an external microphone that converts ambient sounds originating outside the ear into first representative electrical signals;
b. an internal microphone that converts sounds originating inside the ear canal, including at least occlusion sounds, into second representative electrical signals;
c. a signal processing system operatively coupled between the external microphone and the internal microphone that modifies and combines the first and second electrical signals to generate third representative electrical signals; and
d. a receiver that converts the third representative electrical signals into hearing-loss compensating sounds and occlusion-negating sounds and projects the hearing-loss compensating sounds and occlusion-negating sounds into the ear canal, at least one of the receiver and the internal microphone configured with a vent into the volume of the hearing aid.

11. The hearing aid of claim 10, wherein the receiver comprises a vent opening formed between the rear volume of the receiver and the closed cavity of the hearing aid.

12. The hearing aid of claim 10, wherein the internal microphone comprises a vent opening formed between the rear volume of the internal microphone and the closed cavity of the hearing aid.

13. The hearing aid of claim 11, wherein the vent opening of the receiver is formed with a diameter within the range of 0.01 to 0.05 mm and a length of approximately 0.2 mm.

14. The hearing aid of claim 12, wherein the vent opening of the internal microphone is formed with a diameter within the range of 0.01 to 0.03 mm and a length of approximately 0.015 mm.

15. The hearing aid of claim 11, wherein the vent opening of the receiver is formed with a diameter within the range of 0.5 to 1 mm and the receiver further comprises an acoustic resistor adapted to overlie the vent opening.

16. The hearing aid of claim 12, wherein the vent opening of the internal microphone is formed with a diameter within the range of 0.5 to 1 mm and the internal microphone further comprises an acoustic resistor adapted to overlie the vent opening.

17. The hearing aid of claim 11, wherein the vent opening of the receiver is formed as an aperture in the portion of the hearing aid defining the rear volume and a thin tube extending from the aperture into the closed cavity of the hearing aid.

18. The hearing aid of claim 12, wherein the vent opening of the internal microphone is formed as an aperture in the portion of the hearing aid defining the rear volume and a thin tube extending from the aperture into the closed cavity of the hearing aid.
